(19) United States
(12) Patent Application Publication
(10) Pub. No.: US 2006/0255952 A1
(43) Pub. Date: Nov. 16, 2006

(54) Security label

(75) Inventor: Frank Steffen Waegner, Weinheim (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Checkpoint Systems International GmbH, Heppenheim (DE)

(21) Appl. No.: 10/545,868

(22) PCT Filed: Jan. 28, 2004
(86) PCT No.: PCT/EP04/00751

§ 371 Date: Apr. 24, 2006

(30) Foreign Application Priority Data
Feb. 28, 2003 (DE) 203 03 318.3

(51) Int. Cl. G08B 13/14

(52) U.S. Cl. 340/572.8

(57) ABSTRACT

The invention relates to a security tag for protecting objects against theft, comprising an electronically detectable security element which is arranged between a carrier layer and a cover layer. The security tag can be fixed to the object which is to be protected against theft with the aid of a loop which can be made from a strip-shaped extension of the carrier and cover layers. The carrier and cover layers are made of a textile material, preferably Jacquard-fabric, which is made at least partially of polyester. The security tag has a simple structure and is partially suitable for securing small, light objects, such as handbags, sunglasses or similar.

### CROSS-REFERENCE TO RELATED APPLICATIONS

This national stage application claims the benefit under 35 U.S.C. §371 of International Application No. PCT/EP2004/000751 filed on Jan. 28, 2004, entitled SECURITY LABEL, which in turn takes its priority from German Application No. 203 03 318.3 filed on Feb. 28, 2003, and all of whose entire disclosures are incorporated by reference herein.

### BACKGROUND OF THE INVENTION

1. Field of the Invention

This invention relates to a security tag for the protection of objects against theft, with at least one electronically detectable security element arranged between a substrate layer and a cover layer, said security tag being attachable to the object to be secured by means of a loop.

2. Description of Related Art

Security tags for electronic article surveillance systems, which are affixed to the object to be secured by means of a loop are known in the art. In the known systems security elements surrounded by a hard plastic housing are attached to a portion of the object to be secured by means of wire-shaped loops fastened to said housing. Furthermore such security tags comprise means for emitting an electronically detectable signal. Suitable detecting devices generate alternating magnetic fields which excite the security tag into emitting a characteristic signal. This characteristic signal is then received by the detecting devices, whereby an alarm is released.

From DE 199 63 130 A1, for example, security tags in the form of “hard tags” are known, which are comprised of a housing accommodating the means for emitting an electronically detectable signal. Affixed to or integrated into the hard plastic housing is further a fastening device into which a corresponding fastening element may latch. As fastening elements retaining loops, for example, are provided which are essentially a length of wire that is attachable to eyelets, holes or the like on an article to be secured. For this purpose, one free end of the wire is attached to the fastening device of the housing, while the other free end can be affixed to another portion of the housing so that the wire forms a loop. Alternatively, the one free end may also be formed into a kind of ring through which the wire is threaded with its other free end before its attachment to the fastening device. However, such security tags have the disadvantage of being of relatively complex construction, in addition to being heavy and inflexible on account of the bulky housing. Therefore they are predominantly suitable only for the securing of articles of clothing or larger objects. Such security tags are ill-suited for the securing of smaller, light-weight objects such as sunglasses or the like.

From CH 667 339 A5 another security tag is known which can be attached to the object to be secured by means of a wire loop, with the tag involved being however likewise a “hard tag”. Disclosed is further a locking mechanism enabling magnetic unlocking. This mechanism includes a pin which is provided with annular grooves and inserted in a bore of the housing of the security tag, and pellets embedded in an insert in the bore snap into the annular grooves of the pin, thereby securely anchoring the pin. By means of a magnetic release device, the ferromagnetic pellets can be pulled in radially outward direction by a strong magnetic field produced in the device, whereby the lock is again released. For example, the described wire loop may be fastened with its one free end to the security tag, while the other free end includes the described pin which is introduced into the bore of the housing and hence can be releasably fastened thereto. The security tag therein described has likewise the disadvantage of being unsuited to the securing of light-weight objects in addition to being of relatively complex construction.

### BRIEF SUMMARY OF THE INVENTION

It is an object of the present invention to provide a security tag of the type initially referred to, which is very light-weight, of straightforward construction and suited for the securing of small, light-weight objects.

According to the present invention this object is accomplished with a security tag of the type initially referred to in that both the substrate and cover layers and the loop are fabricated from a textile material.

Owing to the exclusive use of textile materials, a very light security tag is obtained which can be affixed easily also to small and light-weight objects as, for example, purses, sunglasses or the like. Because the loop provided for attachment to the object to be secured is also made of the textile material, the weight of the complete security tag is not increased, in contrast to the heretofore known wire loops. Furthermore, damage to the object to be secured can be avoided by the use of a textile loop, which is of special importance in particular in connection with high-quality articles.

The electronically detectable security element of the security tag of the invention is preferably a flexible EAS (electronic article surveillance) element which is preferably active from the onset. When the article is paid for, the cashier removes the tag from the secured merchandise with a special tool so that it can be reused as the above-described hard tag. In contrast to hard tags, the security tag of the invention affords the advantage of lower weight and of being usable for the securing of light-weight merchandise such as sunglasses and the like.

In advantageous embodiments of the invention provision is made for the textile material of the substrate layer to be a fabric, preferably a jacquard fabric, and for the textile material of the substrate and the cover layers to be made of polyester at least in part. The textile material may be made of 100% polyester fibers or of mixed fibers of polyester and one or more further natural or synthetic polymers. The percentage of polyester may be between 30 and 60%, for example, preferably at about 40 or 50%. As additional polymers for the mixed fibers cellulose or viscose can be considered. To manufacture the substrate layer, the polyester fibers or the mixed fibers may be processed as in the manner of a jacquard fabric, for example. The substrate layer also imparts a pleasant appearance to the security tag. Information about the manufacturer of the protected object or about the protected object itself may be woven into the substrate layer and/or imprinted on the substrate layer.

In another advantageous embodiment of the invention provision is made for the substrate layer, the security element and/or the cover layer to be firmly connected with each other at least in part by means of at least one double sided adhesive tape. As double sided adhesive tape an elastic paper fiber fleece, for example, may find application, which has applied to either side thereof a highly aggressive, temperature-resistant acrylic adhesive. It is preferable for the adhesive tape to be transparent and of a very thin overall thickness, that is, a thickness of between 0.10 and 0.12 mm, for example. The adhesive power should be at least 1,550 p (15.2 N)/25 mm, for example. The double sided adhesive tape may be used to adhere the security element to the substrate layer while simultaneously also establishing a connection between the substrate and the cover layers. Preferably, the double sided adhesive tape may be applied to the entire surface area of the cover layer including the region of the loop, hence enabling the security element and the cover layer to be simply adhered to the substrate layer. Alternatively, it is also possible for the double sided adhesive tape to have adhesive points which melt when a predetermined temperature, preferably about 120° C., is reached. This enables the adhesive process to be applied to selected regions and in controllable manner during the manufacturing process.

In a particularly advantageous aspect of the invention provision is made for the cover layer to be of the fleece-type. Alternatively, for example, it would also be possible for the cover layer to be made of a felt-type material, for example, from “synthetic leather”, which is a 100% polyester material. In this case it has a thickness of between 0.5 and 1.0 mm, preferably between 0.7 and 0.8 mm, and a weight of between 250 and 350 g/m². The cover layer imparts a certain stability to the security tag, and yet it is of flexible and light-weight construction. The cover layer of the security tag of the invention is preferably of the fleece-type and significantly thicker than the substrate layer. Advantageously, a mixed fiber of 40 to 50% polyester and 50 to 60% cellulose or viscose is used, with the fibers being structured in the manner of a wet fleece. The weight per unit area of the material can be between 35 and 65 g/m² and preferably at around 37 or 61 g/m².

When in an advantageous aspect of the invention the substrate and the cover layers are of a roundish or rectangular configuration and enclose the security element completely, and when furthermore the loop is manufacturable from a narrow, strip-type extension of the substrate and cover layers, a highly compact security tag made in one integral piece is obtained, which encompasses the security element completely. Since the loop can be manufactured from a narrow, strip-shaped extension of the substrate and cover layers, no additional loop is required which would have to be affixed to the security tag in a subsequent operation. Rather, the extension is integrally connected with the security tag and accordingly a constituent part thereof, so that the loop can be formed in simple manner for fastening to the object to be secured.

The formation of a loop is significantly facilitated by providing at least two apertures in the security tag. At least one of the two apertures may be arranged in the region of the extension and is adapted to be brought into registry with the second aperture in the security tag in order to produce the loop. The loop necessary for attachment to the object to be secured can thus be formed quickly and easily. When a double sided adhesive tape is used, this also ensures the apertures' tearing resistance.

In this context an advantageous aspect of the invention provides for the loop to be fixable in place by means of a locking element which is comprised of two parts connectible with each other by positive engagement and magnetically disengageable from each other through a pin-type member. In an advantageous aspect of the invention the pin-type member is passable through at least two registering apertures in the security tag to fix the two connectible parts of the loop in place. Owing to the use of such a locking element the loop can be formed readily, securely fixed and also released again. In this arrangement the locking element does not contact the object to be secured, thereby avoiding any damage thereto by the locking element. The object to be secured rather contacts exclusively the loop made of the soft, textile material.

The security element is an element of preferably flat and flexible configuration of the sheet- or foil-type and/or can be an EM (electromagnetic), AM (acousto-magnetic), RF (radio frequency) or RF-ID (radio frequency identification) element, for example. Accordingly, in the security tag of the invention any type of security element may be used, provided they are as flat, flexible and light-weight as possible, have the requisite mechanical strength and are designed to emit a characteristic signal.

### BRIEF DESCRIPTION OF SEVERAL VIEWS OF THE DRAWINGS

The present invention will be described in more detail by way of example, reference being had to the Figures of the accompanying drawings. In the drawings,

FIG. 1 is a top plan view of the security tag of the invention; and

FIG. 2 is a schematic cross-sectional view of a security tag of the invention, taken along line 2-2 of FIG. 1.

### DETAILED DESCRIPTION OF THE INVENTION

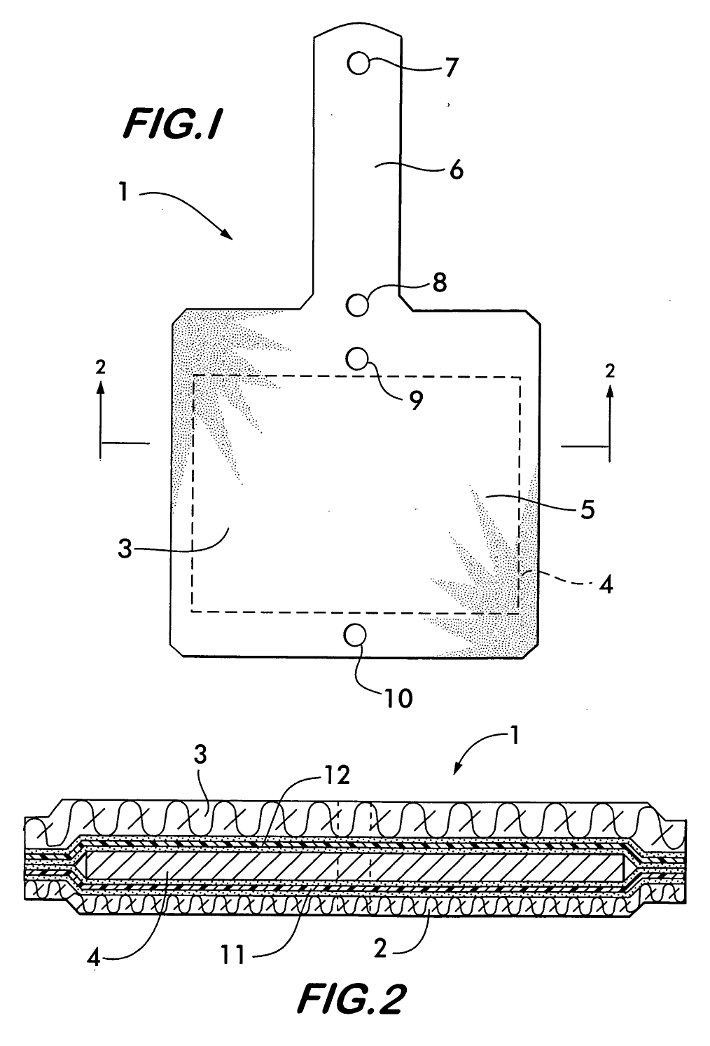

FIG. 2 shows schematically a cross-sectional view, taken along the line 2-2 of FIG. 1, of a security tag 1 of the invention. The security tag 1 has on its front side a substrate layer 2 preferably made of a woven textile material of 100% polyester, for example, and a cover layer 3 on its rear side. The substrate layer 2 imparts the desired appearance to the security tag 1 and, owing to its thickness, also a certain strength, without however adversely affecting the flexibility and the weight of the security tag 1. On its rear side the substrate layer 2 has its full surface area covered by the cover layer 3. The cover layer 3 is preferably thicker than the substrate layer 2 and is preferably made of a fleece-type material. As fibers for the fleece-type material mixed fibers of 40 to 50% polyester and 50 to 60% cellulose or viscose may be considered, for example. Particularly preferable according to the invention are fibers made of 40% polyester and 60% cellulose, or 50% polyester and 50% viscose. The fleece-type material is light-to medium-weight, multidirectionally stable and boilproof. Sandwiched between the substrate layer 2 and the cover layer 3 is a security element 4 which may be, for example, an EM, AM, RF or RF-ID element. The security element 4 is a sheet- or foil-type element which, when constructed as an RF element, includes an electric oscillating circuit using etched conducting tracks on a foil. At all events it is completely enclosed between the substrate layer 2 and the cover layer 3, that is, substrate and cover layers 2, 3 protrude beyond the security element 4 on all sides and have their edge regions adhesively bonded together. Both the security element 4 and the substrate layer 2 as well as the cover layer 3, the security element 4 and the substrate layer 2 may be adhered to each other by means of a double sided adhesive tape 11 or by means of a double sided tape 11 and 12, respectively. which may be a very thin (for example, 0.11 mm thick) paper fiber fleece having acrylic adhesive applied to either side thereof. The very thin double sided adhesive tapes 11 and 12 are shown in FIG. 2.

The double sided adhesive tape 11, 12 may also be made of PVC.

FIG. 1 shows a top plan view of the security tag 1, which is comprised of the rear cover layer 3, the front substrate layer 2 not visible in this Figure, and the security element 4 sandwiched between these two layers and indicated in broken lines. The body 5 of the security tag 1 is rectangular with rounded edges. The cover layer 3 and the substrate layer 2 may be cut out from suitable webs of material using, for example, a laser cutter. The body 5 merges seamlessly with a narrow strip-type extension 6 serving to form a loop. Using the loop formed by the extension 6, the security tag 1 can be affixed to an object as, for example, a light-weight and high-quality article of merchandise. The loop can be fitted around the handle of a lady's purse, for example. Since the security tag of the invention is mainly made of textile material, it is particularly light-weight and flexible and can therefore be affixed also to smaller articles. Arranged in the region of the extension 6 and the body 5 area at least two apertures 7 and 8, respectively, with two more apertures 9, 10 being preferably arranged in the region of the body 5. The apertures 7, 8, 9, 10 may likewise be cut out from the material of the substrate layer 2 and the cover layer 3 as by means of a laser cutter. The apertures 7, 8, 9, 10 serve the function of securing a loop formed by the extension 6. The loop is formed by bringing the aperture 7 at the upper end of the extension 6 into registry with one of the other apertures 8, 9, 10, followed by fixing the loop by means of a suitable locking element (not shown). To form the loop it is sufficient to provide, in addition to the aperture 7, another aperture 8, 9 or 10 and preferably the aperture 8 at the lower end of the extension 6. However, when four or more apertures are provided as in the present embodiment, the radius of the loop can be varied or selected freely by selecting the apertures 7, 8, 9, 10 to be brought into registry. Hence the security tag 1 of the invention can be flexibly matched to the dimensions of the object to be secured and to the desired type of fastening. The locking element, herein not shown, for securing the loop may be comprised, for example, of two parts which are connectible with each other in a positive-engagement relationship and again detachable magnetically using a pin-type member, as is known from CH 667 339 A5 initially referred to. In this arrangement the pin-type member is passed through at least two registering apertures 7, 8, 9, 10 in the security tag 1 in order to fix the two loop parts to be connected.

1.-12. (canceled)

13. A security tag for the protection of an object against theft, said security tag comprising:
at least one electronically detectable security element arranged between a substrate layer and a cover layer combined to form a body;
said substrate comprising a first textile material and said cover layer comprising a second textile material and wherein said body merges seamlessly in one integral piece with a narrow strip-type extension of said substrate and said cover layer, and
wherein said narrow strip-type extension is manipulated with said body to form a loop for securing said tag to the object.

14. The security tag as claimed in claim 13 wherein said first textile comprises jacquard fabric.

15. The security tag as claimed in claim 13 wherein said first and second textile materials comprise polyester.

16. The security tag as claimed in claim 13 wherein said substrate layer, said security element and/or said cover layer are secured to each other via at least one double sided adhesive tape.

17. The security tag as claimed in claim 16 wherein said double sided adhesive tape comprises a paper fiber fleece which has applied to either side thereof an acrylic adhesive and/or includes adhesive points which melt when a predetermined temperature is reached.

18. The security tag as claimed in claim 17 wherein said predetermined temperature comprises approximately 120° C.

19. The security tag as claimed in claim 13 wherein said cover layer comprises a felt-type material.

20. The security tag as claimed in claim 13 wherein said cover layer comprises a fleece-type material.

21. The security tag as claimed in claim 13 wherein said substrate and said cover layer comprise a roundish or rectangular configuration and enclose said security element completely.

22. The security tag as claimed in claim 13 comprising at least two apertures in said security tag for forming said loop.

23. The security tag as claimed in claim 22 wherein at least one of said two apertures is arranged in a region of the extension and is adapted to be brought into registry with the other one of said at least two apertures in the security tag for forming said loop.

24. The security tag as claimed in claim 23 wherein said loop is fixable in place using a locking element comprising two parts connectible with each other by positive engagement and magnetically disengageable from each other through a pin-type member.

25. The security tag as claimed in claim 24 wherein said pin-type member is passable through said at least two registering apertures in said security tag for fixing said loop in place.

26. The security tag as claimed in claim 13 wherein said security element comprises a flat and flexible construction.

27. The security tag as claimed in claim 26 wherein said security element comprises an EM element.

28. The security tag as claimed in claim 26 wherein said security element comprises an AM element.

29. The security tag as claimed in claim 26 wherein said security element comprises an RF element.

30. The security tag as claimed in claim 26 wherein said security element comprises an RF-ID element.
